(19) United States
(12) Patent Application Publication
(10) Pub. No.: US 2010/0016139 A1
(43) Pub. Date: Jan. 21, 2010

(54) Centrifuge design and utilization for multistep multistage operations and processes

(76) Inventor: Mohamed Elgafi, Redondo Beach, CA (US)

Correspondence Address: MOHAMED ELGAFI, 1343 S. GERTRUDA AVE, REDONDO BEACH, CA, 90277, US

(21) Appl. No.: 12/218,792

(22) Filed: Jul. 17, 2008

(51) Int. Cl. B01J 19/28

(52) U.S. Cl. 494/37

(57) ABSTRACT

Centrifuge design and operation for multiple unit operation and processing functions as a centrifuge, reactor, process vessel, and contact apparatus, thus eliminating numerous additional equipment, handling, cleaning and validation steps that are required by the standards, codes and regulations for each manufacturing step in various industries.

### BACKGROUND OF THE INVENTION

1. Prior Art

Centrifuges were conceived, designed, manufactured, operated and maintained for the sole purpose of separation of two phases, such as liquids/solids, multiple phases or components in the same phase with different specific gravity. This limits the utilization to one separation step. What is known in certain industries as CIP and/or SIP (clean in place) and validation are required to comply with the CFRs (Codes of Federal Regulation). In the biotech, pharmaceutical and allied industries, centrifuges are utilized a small fraction of the time. The balance of the time it's being loaded, unloaded, cleaned (CIP/SID), inspected and validated. All are specialized skilled-labor intensive steps.

2. Field of the Invention

This invention covers the development of a device capable of performing multiple unit operations and processes. This constitutes saving of additional equipment, handling, CIP/SIP, validation and will result in considerable increase in the production rates per device and per process system.

3. Objects and Advantages

(1) Increase in the efficiency of production process utilizing centrifuges.

(2) Utilization of a centrifuge as multiple process equipment and total process system.

(3) Breaking new grounds by bringing into being new processes.

(4) Boasting the feasibility of current and upcoming operations and processes.

### DESCRIPTIONS

Centrifuges are extensively used as a separation device in the pharmaceutical, biotech, food processing, chemicals, allied and any process whenever separation is needed.

In this invention, the centrifuge is designed and utilized as a centrifuge and as a reactor/processing vessel/contact apparatus, where unit operations and chemical reactions can be conducted.

A number of predetermined design modifications are needed to provide means for process requirements. That means a basic centrifuge is retrofitted and/or designed to function as a complete process system.

Centrifugal separation processes are generally more efficient than drying, evaporation and distillation. Additionally, the development of high strength materials expanded the envelope to achieve higher rotating speed, i.e. higher G's. Centerfuges producing 10,000 G and over are normally called super centerfuges.

Predetermined design features include: rotor(s), basket(s), bowel(s), casing(s), jacket(s) and coil(s) in addition to sonic, electro, electromagnetic, magnetic and radiation devices.

Predetermined design features also includes a parallel device chemically, physically and thermodynamically coupled to the centrifuge/reactor/process vessel and contact apparatus unit.

I claim:

1.0. Development of a centrifuge design and utilization for multiple operation and processing functions to provide separation and actual processing.

1.1. Utilizing the said centrifuge/processing vessel/reactor/contact apparatus device for the separation, processing and purification of thymus nuclear proteins.

1.2. Utilizing the said centrifuge/processing vessel/reactor/contact apparatus device for the removal of cholesterol from butter, butter oil and animal fat.

1.3. Utilizing the centrifuge, reactor, process vessel and contact apparatus for pH adjustment for the production of thymus nuclear proteins.

1.4. Utilizing the centrifuge, reactor, process vessel and contact apparatus for pH adjustment.

1.5. Utilizing the said centrifuge in the pharmaceutical, biotech and pharmaceutical and food processing.

1.6. Utilizing the said centrifuge, reactor, process vessel and contact apparatus for meat tenderizing.

1.7. Utilizing centrifugal and/or super centrifuges/process systems for peptides synthesis.

1.8. Utilizing centrifuges and/or super centrifuges/process systems for load removal from good products including balsamic and red wine vinegars.

1.9. Utilizing centrifuges and/or super centrifuges/process systems for the separation of various palm oil components.

1.10. Utilizing centrifuges and/or super centrifuges/process systems for separation of multi-components, hydrocarbons, and feed stocks.
